(19) United States
(12) Patent Application Publication
(10) Pub. No.: US 2026/0211572 A1
(43) Pub. Date: Jul. 23, 2026

(54) METHOD FOR ESTABLISHING MEMORY CELL GROUP

(71) Applicant: Winbond Electronics Corp., Taichung City (TW)

(72) Inventors: Kuo-Min Liao, Taichung City (TW); Tien-Yu Liao, Taichung City (TW); Chien-Han Liao, Kaohsiung City (TW)

(73) Assignee: Winbond Electronics Corp., Taichung City (TW)

(21) Appl. No.: 19/570,127

(22) Filed: Mar. 17, 2026

Related U.S. Application Data
(63) Continuation-in-part of application No. 18/677,916, filed on May 30, 2024.

(30) Foreign Application Priority Data
Apr. 25, 2024 (TW) 113115553

(51) Int. Cl. G06F 3/06

(52) U.S. Cl. CPC G06F 3/0644; G06F 3/0604; G06F 3/0679

(57) ABSTRACT

A method for establishing a memory cell group includes following steps. A layout pattern of a memory cell array including a plurality of memory cells is drawn according to layout data. A recognition step is performed on the layout pattern. The recognition step includes: dividing the memory cells in an n^{th} row of rows in the memory cell array into row groups, where the row groups are identical, and the memory cells in the row group are different; determining whether preceding n rows and succeeding n rows of the rows are repeated. According to a recognition result of the recognition step, a portion of the memory cells is collectively established as a memory cell repeating group, so that the memory cell array is composed of a plurality of the memory cell repeating groups. A memory cell type table associated with the memory cell repeating groups is generated.

### CROSS-REFERENCE TO RELATED APPLICATION

This application is a continuation-in-part application of and claims the priority benefit of U.S. patent application serial no. 18/677,916, filed on May 30, 2024, which claims the priority benefit of Taiwan patent application serial no. 113115553, filed on April 25, 2024. The entirety of each of the above-mentioned patent applications is hereby incorporated by reference herein and made a part of this specification.

### BACKGROUND

### Technical Field

The disclosure relates to a method for establishing a memory cell group including different memory cells.

### Description of Related Art

In the early stages of memory device development, memory cells of different types in the memory device are typically classified for subsequent analysis of product yield and failure modes. Currently, the memory cell types are generally defined manually based on layer stacking structures of the memory cells. Subsequently, enumeration and classification are performed to define groups including the memory cells of different types.

However, manual classification of the memory cell groups often consumes a considerable amount of time and is prone to high error rates, which may consequently lead to ineffective and inaccurate analyses of product yield and failure modes.

### SUMMARY

The disclosure provides a method for establishing a memory cell group. In the method, a layout pattern of the memory cell array is recognized, so as to rapidly and accurately classify the memory cells and define groups composed of the memory cells of different types.

According to an embodiment of the disclosure, a method for establishing a memory cell group is provided, and the method includes following steps. A layout pattern of a memory cell array including a plurality of memory cells is drawn according to layout data. Different memory cells in the layout pattern are represented by different display effects. A recognition step is performed on the layout pattern. The recognition step includes the following. The memory cells in an n^{th} row of rows in the memory cell array are divided into a plurality of row groups, the row groups are identical, and the memory cells in the row groups are different. Whether preceding n rows and succeeding n rows of the rows are repeated is determined. According to a recognition result of the recognition step, a portion of the memory cells is collectively established as a memory cell repeating group, so that the memory cell array is composed of a plurality of the memory cell repeating groups. A memory cell type table associated with the memory cell repeating groups is generated.

According to an embodiment of the disclosure, a method for establishing a memory cell group is provided, and the method includes following steps. A layout pattern of a memory cell array including a plurality of memory cells and a plurality of dummy memory cells is drawn according to layout data. Different memory cells in the layout pattern are represented by different display effects, and a first row of rows in the memory cell array comprises the dummy memory cells. A recognition step is performed on the layout pattern. The recognition step includes the following. The memory cells in an n^{th} row of the rows in the memory cell array are divided into a plurality of row groups, the row groups are identical, and the memory cells in the row groups are different. Whether in the row groups in the n^{th} row there are memory cells which are identical to the memory cells in the row group in the first row is determined, where n is a positive integer greater than 1. According to a recognition result of the recognition step, a portion of the memory cells is collectively established as a memory cell repeating group, so that the memory cell array is composed of a plurality of the memory cell repeating groups. A memory cell type table associated with the memory cell repeating groups is generated.

In view of the above, in the method of establishing the memory cell group according to one or more embodiments of the disclosure, the layout pattern of the memory cell array is recognized and classified, and then a corresponding memory cell type table is generated. Therefore, in subsequent analyses of product yield and failure modes, which step in the manufacturing process has problems may be quickly identified according to the corresponding memory cell type table, which is conducive to improving the wafer manufacturing process and enhancing productivity and yield rate.

### BRIEF DESCRIPTION OF THE DRAWING

FIG. 1 is a block diagram of an electronic device according to an embodiment of the disclosure.

FIG. 2 is a flowchart of a method for establishing a memory cell group according to a first embodiment of the disclosure.

FIG. 3 is an example of a layout structure diagram according to the first embodiment of the disclosure.

FIG. 4A to FIG. 4F are schematic views of the method for establishing the memory cell group according to the first embodiment of the disclosure.

FIG. 5 is an example of a memory cell type table according to the first embodiment of the disclosure.

FIG. 6 is a flowchart of a method for establishing a memory cell group according to a second embodiment of the disclosure.

FIG. 7A to FIG. 7G are schematic views of the method for establishing the memory cell group according to the second embodiment of the disclosure.

FIG. 8 is an example of a memory cell type table according to the second embodiment of the disclosure.

### DESCRIPTION OF THE EMBODIMENTS

In a method of establishing a memory cell group according to one or more embodiments of the disclosure, a layout pattern of a memory cell array is recognized, so as to rapidly and accurately classify memory cells and define groups composed of the memory cells of different types, which is conducive to subsequent analyses of product yield and failure modes.

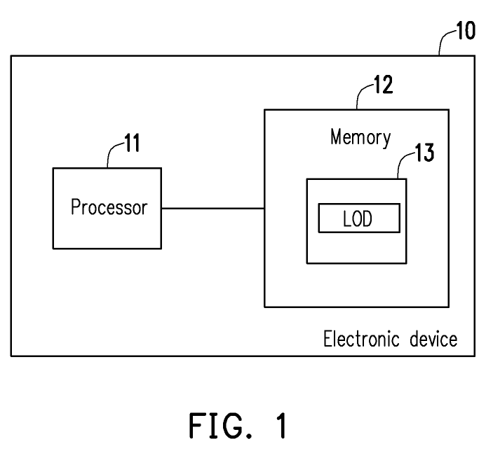

With reference to FIG. 1, an electronic device 10 is, for example, an electronic product such as a desktop computer, a server, or a notebook computer. The electronic device 10 includes a processor 11 and a memory 12. The memory 12 is coupled to the processor 11. The processor 11 is, for example, a Central Processing Unit (CPU), a programmable microprocessor, an embedded control chip, or the like. The memory 12 is, for example, any type of fixed or removable Random Access Memory (RAM), Read-Only Memory (ROM), flash memory, hard disk, or other similar devices or combinations of these devices.

The memory 12 includes a layout database 13. The layout database 13 stores layout data LOD of a wafer that serves as a detection target. The layout data LOD includes structure information of a memory cell array in the wafer and shape, type, and position information (including coordinate positions) of each layer. In the present embodiment, each layer may have two types or four types, but the disclosure is not limited thereto.

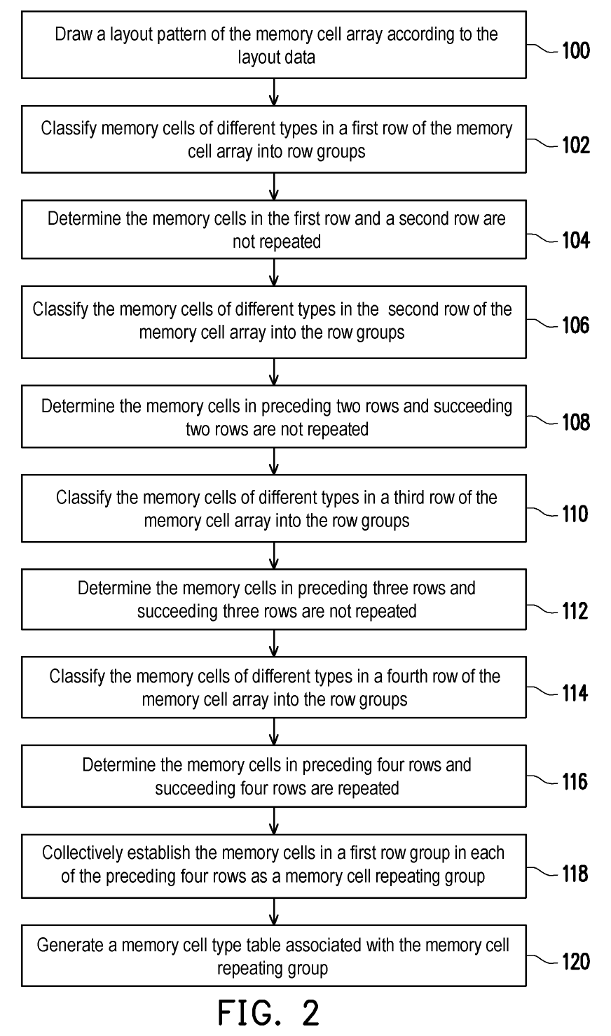

With reference to FIG. 1 and FIG. 2, the method for establishing the memory cell group of the present embodiment is adapted to the electronic device 10 of FIG. 1. The steps of the method for establishing the memory cell group according to first embodiment of the disclosure are described below in conjunction with various components in the electronic device 10.

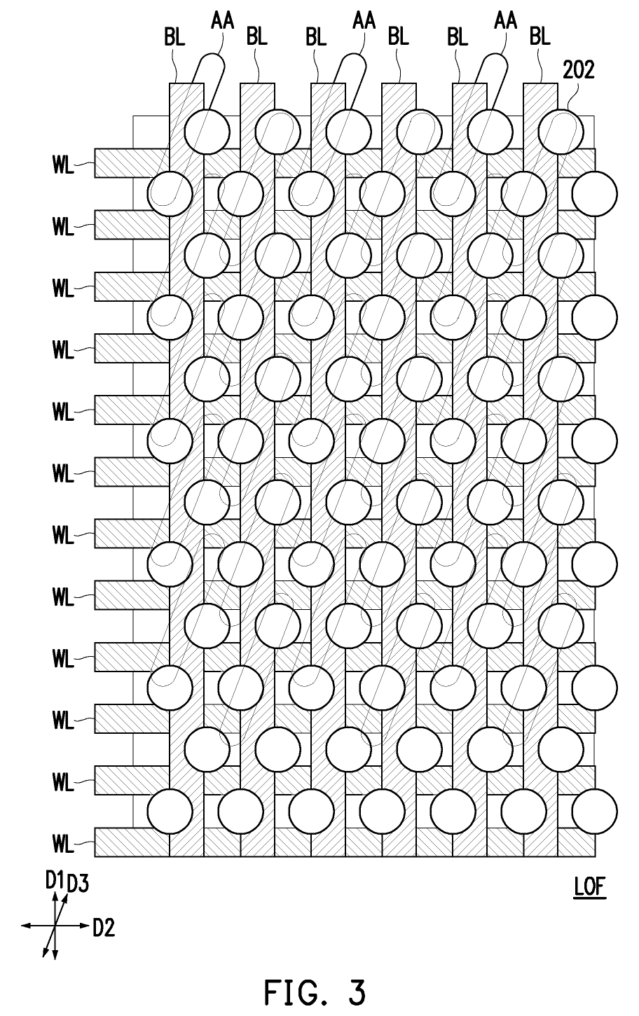

In step 100, the processor 11 draws a layout pattern 200 of the memory cell array in the wafer according to the layout data LOD. Specifically, the processor 11 may first draw a layout structure diagram LOF of the memory cell array according to the structure information and the shape, type, and position information of each layer recorded in the layout data LOD, and store the layout structure diagram LOF in the memory 12. As shown in FIG. 3, in the layout structure diagram LOF, there are multiple active regions AA. These active regions AA may be arranged along the first direction (column direction) D1 and the second direction (row direction) D2. These active regions AA may be multiple portions of a substrate separated by components isolation structures (not shown). Each active region AA extends in the third direction D3 that intersects with the first direction D1 and the second direction D2.

Multiple word lines WL extend the in second direction D2, and each word line WL may span across multiple active regions AA. Each memory cell 202 in the memory cell array may be defined in an overlapping region of one active region AA and one word line WL. In addition, multiple bit lines BL extend in the first direction D1, and each bit line BL spans across multiple active regions AA.

In addition to the structures of the active regions AA, the word lines WL, and the bit lines BL, since the layout data LOD includes the shape, type, and position information of each layer, the processor 11 may present positions and ranges of various layers in the layout structure diagram LOF with different display effects (such as different colors or marks).

Next, the processor 11 may analyze the layout structure diagram LOF to obtain type of each memory cell 202 constituting the memory cell array, and accordingly draw the layout pattern 200. For example, the processor 11 may analyze each pixel position in the layout structure diagram LOF one by one in units of pixels to obtain the types of layers stacked on the structure corresponding to each pixel position. In this way, the processor 11 may obtain the type constituting each memory cell 202 according to the types of layers at the pixel positions where each memory cell 202 is located in the layout structure diagram LOF. Moreover, the processor 11 may draw the layout pattern 200 of the memory cell array by using different display effects (such as different colors or marks) to represent the memory cells 202 having different types.

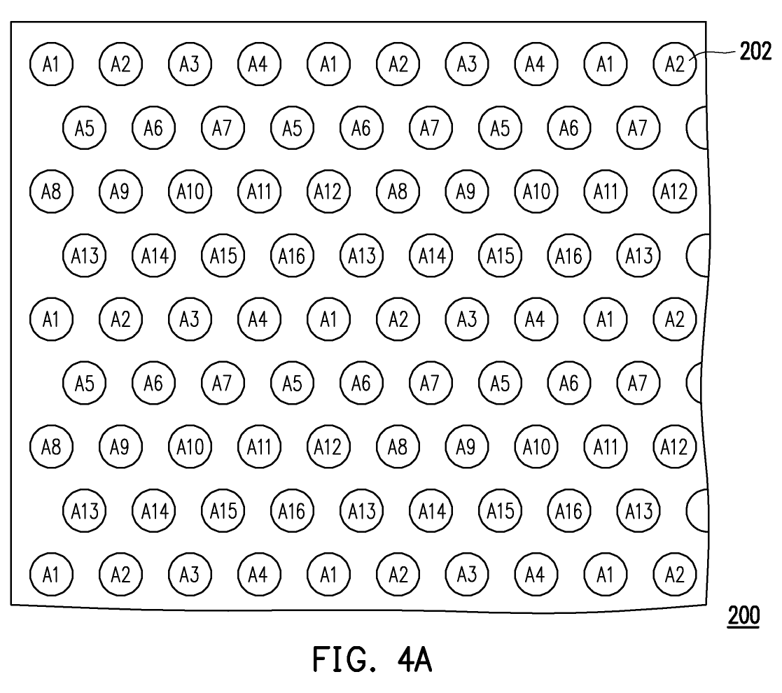

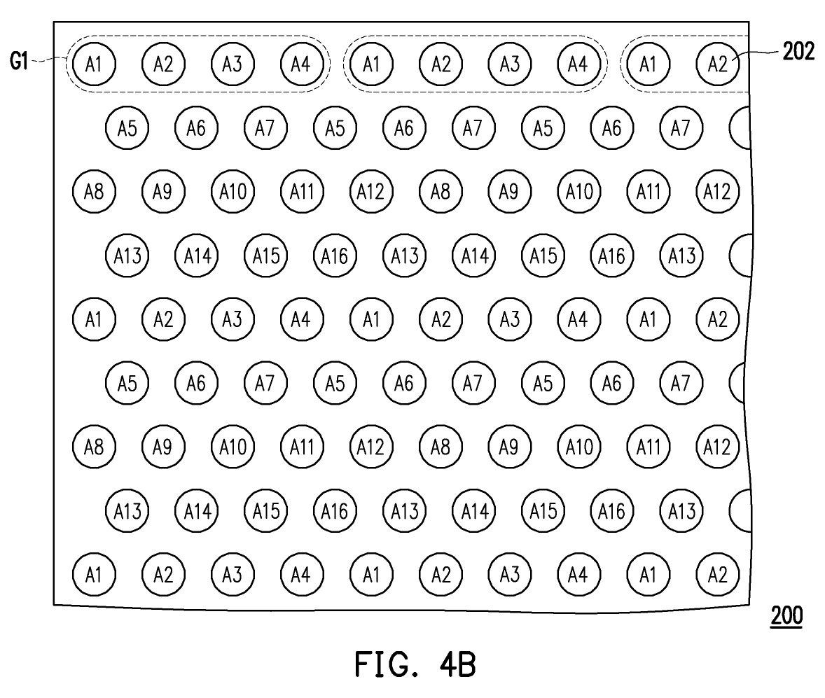

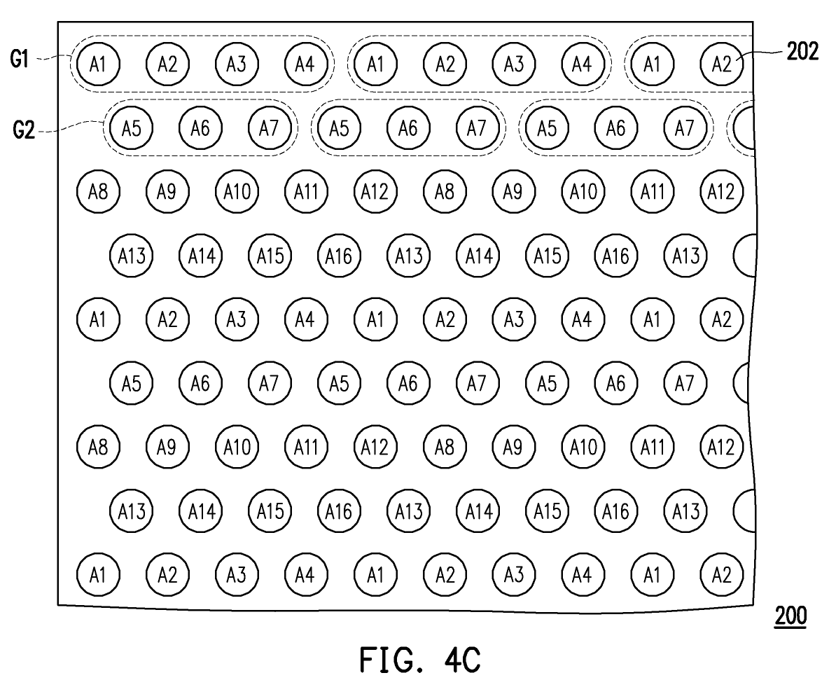

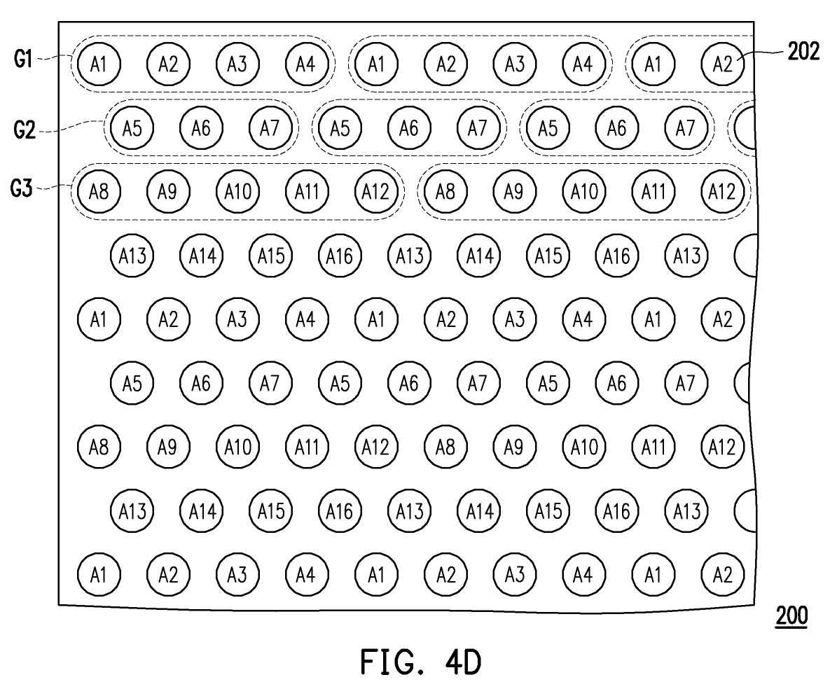

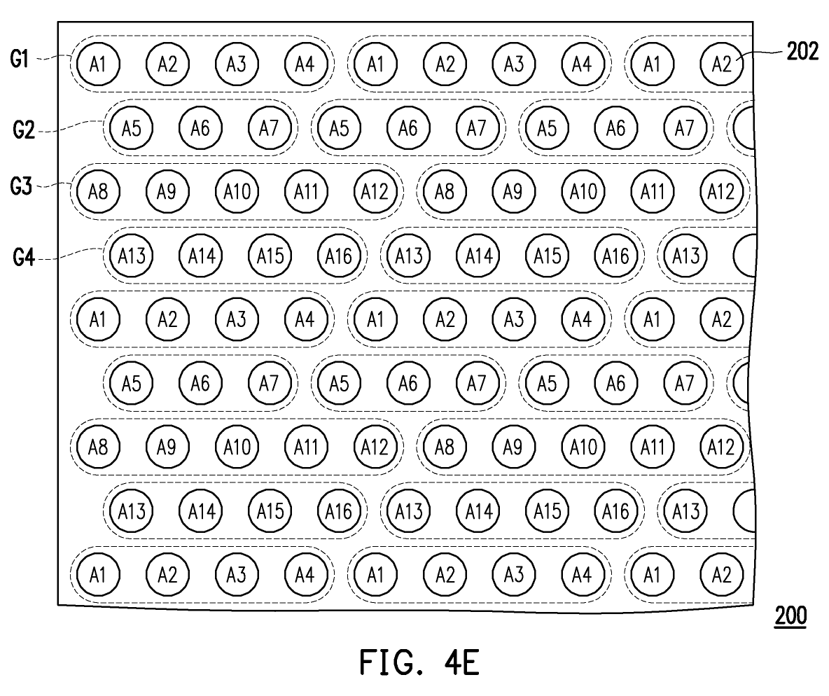

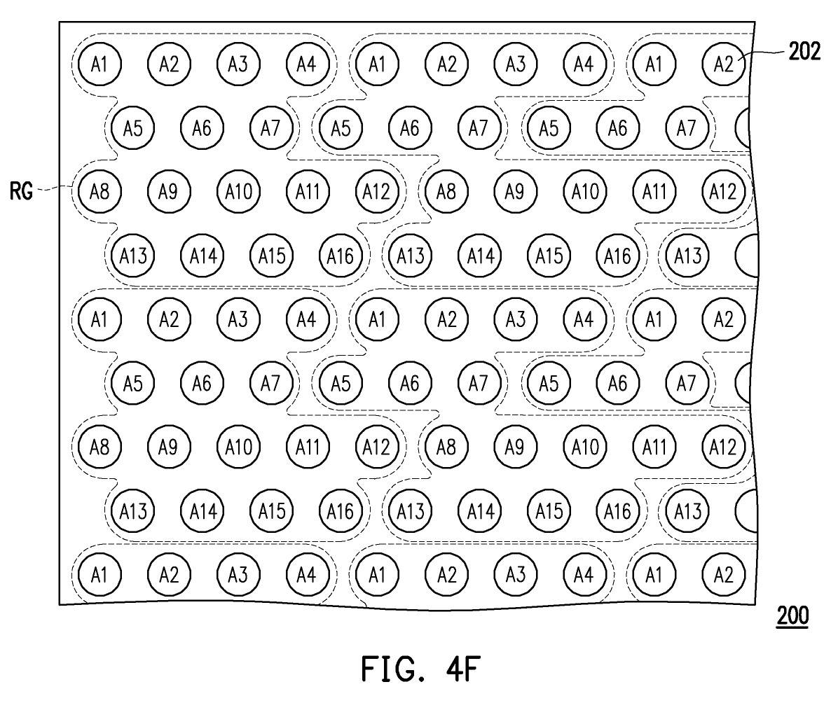

With reference to FIG. 4A, the memory cell array presented by the layout pattern 200 includes the memory cells 202. The memory cells 202 in two adjacent columns are alternately arranged, and the memory cells 202 in two adjacent rows are alternately arranged, which should however not be construed as a limitation in the disclosure. The memory cell array presented by the layout pattern 200 includes the memory cells 202 of different types, the memory cells 202 of different types are set repeatedly according to a specific form or standard, and a memory cell group that does not include the memory cells 202 of the same type may be established.

In the memory cell array presented by the layout pattern 200, according to the types of the memory cells 202, the memory cells 202 are respectively marked as A1, A2, A3, …, and A16. In addition, the memory cell array presented by the layout pattern 200 is composed of a plurality of identical memory cell groups; that is, the memory cell array presented by the layout pattern 200 is composed of repeated memory cell groups. Therefore, in this embodiment, the memory cell groups may be referred to as memory cell repeating groups.

In this embodiment, "the memory cells of different types" mean that layer stacking structures of the memory cells are different. Specifically, the memory cells are composed of various layer stacking structures, and depending on the manufacturing steps, different memory cells may have different layer stacking structures. Therefore, the memory cell array presented by the layout pattern 200 includes the memory cells 202 of different types, which should however not be construed as a limitation in the disclosure. In other embodiments, the expression "the memory cells are different" may mean that the memory cells are different in features other than the layer stacking structures.

Therefore, this embodiment aims to classify the memory cells with different layer stacking structures into one memory cell repeating group through pattern recognition, so that the memory cell array may be defined as being composed of the memory cell repeating groups.

In this embodiment, the processor 11 may perform, on the layout pattern 200, the following recognition step:

(1) dividing the memory cells in an n^{th} row of rows in the memory cell array into a plurality of row groups, where the row groups are identical, and the memory cells in the row groups are different;

(2) determining whether preceding n rows and succeeding n rows of the rows are repeated.

In this embodiment, the expression "the preceding n rows and the succeeding n rows are repeated" means that the memory cells in the preceding n rows and the memory cells in the succeeding n rows are repeated. In other words, the group composed of the memory cells in the preceding n rows is the same as the group composed of the memory cells in the succeeding n rows.

Next, with reference to FIG. 2 and FIG. 4B, the processor 11 may recognize the layout pattern 200 of the memory cell array. In step 102, the processor 11 recognizes the memory cells 202 in the first row of the memory cell array presented by the layout pattern 200, and divides the memory cells 202 in the first row into a plurality of row groups G1.

In this step, according to the types of the memory cells 202 in the first row, starting from the first memory cell 202 in the first row, the memory cells 202 of non-repeated types are classified into the row groups G1. In addition, since the memory cells 202 in the memory cell array presented by the layout pattern 200 are set repeatedly according to a specific form or standard, the memory cells 202 in the first row may be divided into a plurality of identical row groups G1. In this embodiment, the memory cells 202 in the first row may be divided into the row groups G1, and the row groups G1 include four different memory cells 202 (respectively marked as A1, A2, A3, and A4), which should however not be construed as a limitation in the disclosure. In other words, in the first row of the memory cell array presented by the layout pattern 200, the memory cells 202 are sequentially arranged and set in a manner marked as A1, A2, A3, and A4.

Next, in step 104, the processor 11 determines whether the first row and the second row are repeated. In this embodiment, since the memory cells 202 in the first row are different from the memory cells 202 in the second row, it is determined that the first row and the second row are not repeated.

After that, with reference to FIG. 2 and FIG. 4C, in step 106, the processor 11 recognizes the memory cells 202 in the second row of the memory cell array presented by the layout pattern 200, and divides the memory cells 202 in the second row into a plurality of row groups G2. In this embodiment, the memory cells 202 in the second row may be divided into the row groups G2, and the row groups G2 include three different memory cells 202 (respectively marked as A5, A6, and A7), which should however not be construed as a limitation in the disclosure.

Next, in step 108, the processor 11 determines whether the preceding two rows (the first and second rows) and the succeeding two rows (the third and fourth rows) are repeated. In this embodiment, since the memory cells 202 in the first and second rows are different from the memory cells 202 in the third and fourth rows, it is determined that the preceding two rows and the succeeding two rows are not repeated.

With reference to FIG. 2 and FIG. 4D, in step 110, the processor 11 recognizes the memory cells 202 in the third row of the memory cell array presented by the layout pattern 200, and divides the memory cells 202 in the third row into a plurality of row groups G3. In this embodiment, the memory cells 202 in the third row may be divided into the row groups G3, and the row groups G3 include five different memory cells 202 (respectively marked as A8, A9, A10, A11, and A12), which should however not be construed as a limitation in the disclosure.

Next, in step 112, the processor 11 determines whether the preceding three rows (the first, second, and third rows) and the succeeding three rows (the fourth, fifth, and sixth rows) are repeated. In this embodiment, since the memory cells 202 in the first, second, and third rows are different from the memory cells 202 in the fourth, fifth, and sixth rows, it is determined that the preceding three rows and the succeeding three rows are not repeated.

With reference to FIG. 2 and FIG. 4E, in step 114, the processor 11 recognizes the memory cells 202 in the fourth row of the memory cell array presented by the layout pattern 200, and divides the memory cells 202 in the fourth row into a plurality of row groups G4. In this embodiment, the memory cells 202 in the fourth row may be divided into the row groups G4, and the row groups G4 include four different memory cells 202 (respectively marked as A13, A14, A15, and A16), which should however not be construed as a limitation in the disclosure.

Next, in step 116, the processor 11 determines whether the preceding four rows (the first, second, third, and fourth rows) and the succeeding four rows (the fifth, sixth, seventh, and eighth rows) are repeated. In this embodiment, since the memory cells 202 in the memory cell array are set repeatedly according to a specific form or standard, ensuring that the memory cells 202 in the first, second, third, and fourth rows are the same as the memory cells 202 in the fifth, sixth, seventh, and eighth rows, it is determined that the preceding four rows and the succeeding four rows are repeated.

With reference to FIG. 2 and FIG. 4F, in step 118, after determining that the preceding four rows and the succeeding four rows are repeated, the processor 11 collectively establishes the memory cells 202 in the first row group in each of the preceding four rows as a memory cell repeating group. In other words, the memory cells 202 (respectively marked as A1, A2, A3, and A4) in the first row group G1 in the first row, the memory cells 202 (respectively marked as A5, A6, and A7) in the first row group G2 in the second row, the memory cells 202 (respectively marked as A8, A9, A10, A11, and A12) in the first row group G3 in the third row, and the memory cells 202 (respectively marked as A13, A14, A15, and A16) in the first row group G4 in the fourth row, a total of 16 memory cells 202, are collectively established as a memory cell repeating group RG.

In this embodiment, the memory cell repeating group RG includes 16 different memory cells 202, and the memory cells 202 of 16 types cover all types of memory cells in the memory cell array presented by the layout pattern 200. As such, based on the memory cell repeating group RG, the memory cell array presented by the layout pattern 200 may be considered as being composed of a plurality of the memory cell repeating groups RG.

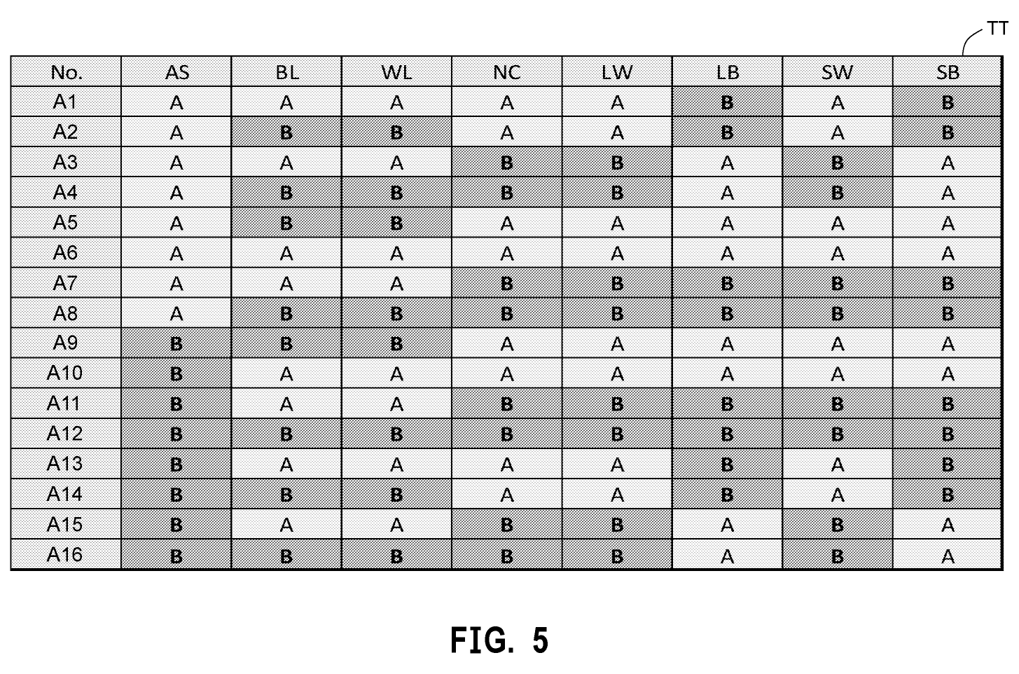

Finally, in step 120, the processor 11 generates a memory cell type table TTB1 associated with the memory cell repeating group RG. As shown in FIG. 5, the memory cell type table TTB1 lists the layers possessed by the memory cells 202 marked as A1~A16 in the memory cell repeating group RG, including AS layer, BL layer, WL layer, NC layer, LW layer, LB layer, SW layer, and SB layer. Each of these layers has two types: Type A and Type B. In the memory cell type table TTB1, the memory cell 202 marked as A1 has AS layer, BL layer, WL layer, NC layer, LW layer, and SW layer of Type A, and LB layer and SB layer of Type B. The memory cell 202 marked as A2 has AS layer, NC layer, LW layer, and SW layer of Type A, and BL layer, WL layer, LB layer, and SB layer of Type B, and so on.

It should be noted that Type A and Type B are only used to represent two types of the layer. That is, Type A of different layers may not necessarily be the same, and Type B of different layers may not necessarily be the same.

In this embodiment, the preceding four rows and the succeeding four rows are repeated, which should however not be construed as a limitation in the disclosure. In other embodiments, when the preceding n rows and the succeeding n rows are not repeated, the above recognition step is performed on the next row until the preceding n rows and the succeeding n rows are repeated, and the memory cell repeating group is established.

According to the above method, the layout pattern of the memory cell array may be rapidly and accurately recognized and classified, so as to establish the memory cell repeating groups, and then generate a corresponding memory cell type table to categorize the memory cells on the manufactured wafer. Thus, when defects are discovered due to subsequent analyses of product yield and failure modes, the specific application program may first be used to analyze which portion of the region (memory array) in the wafer the defects are concentrated in, and then combined with the generated memory cell type table to find out the layer types possessed by the memory cells where defects occur, thereby quickly identifying which step in the manufacturing process has problems. Therefore, the disclosure is conducive to improving the wafer manufacturing process and enhancing productivity and yield rate.

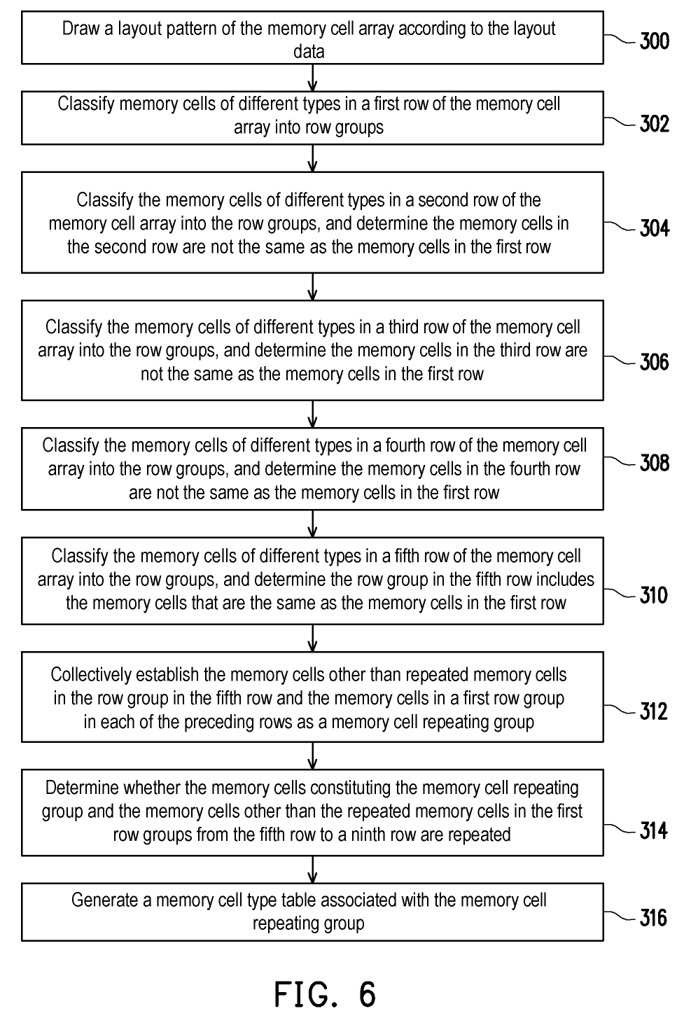

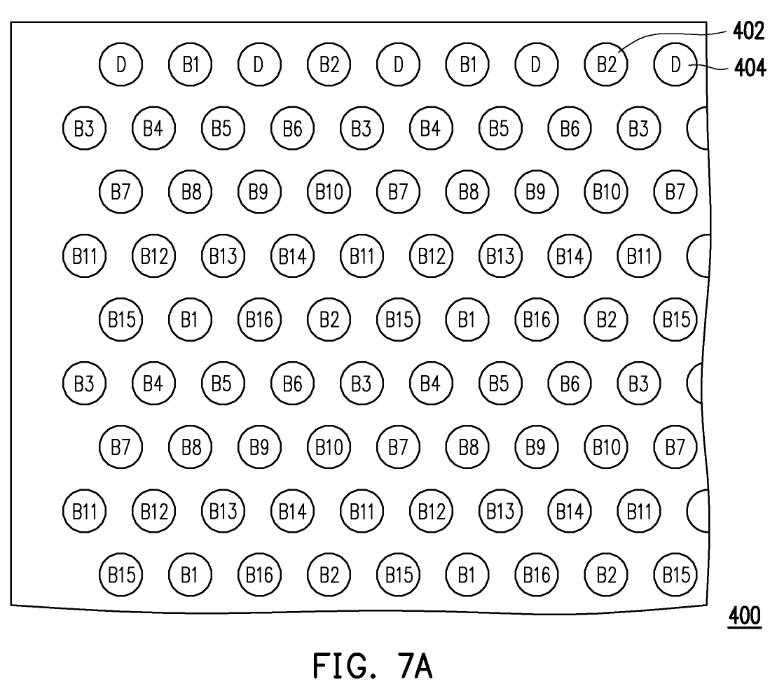

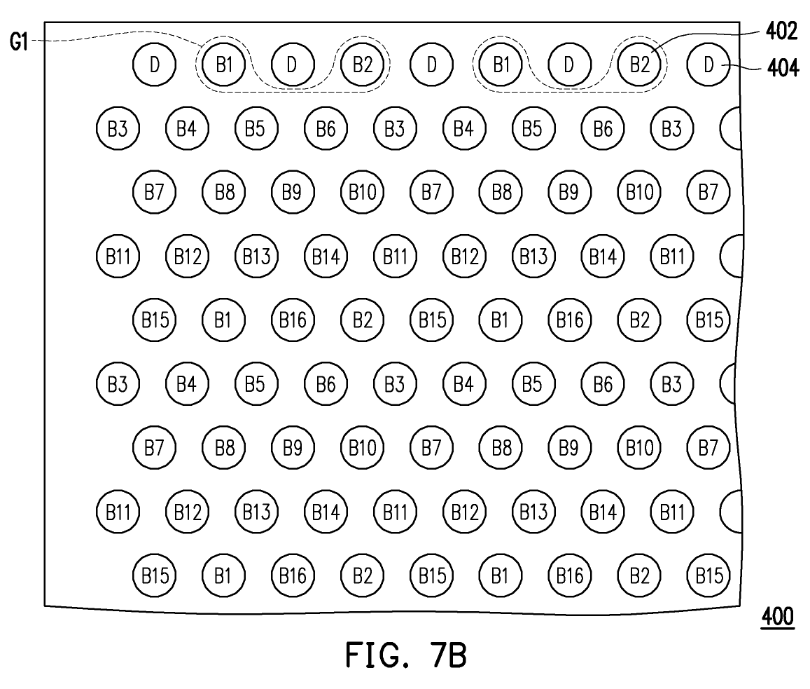

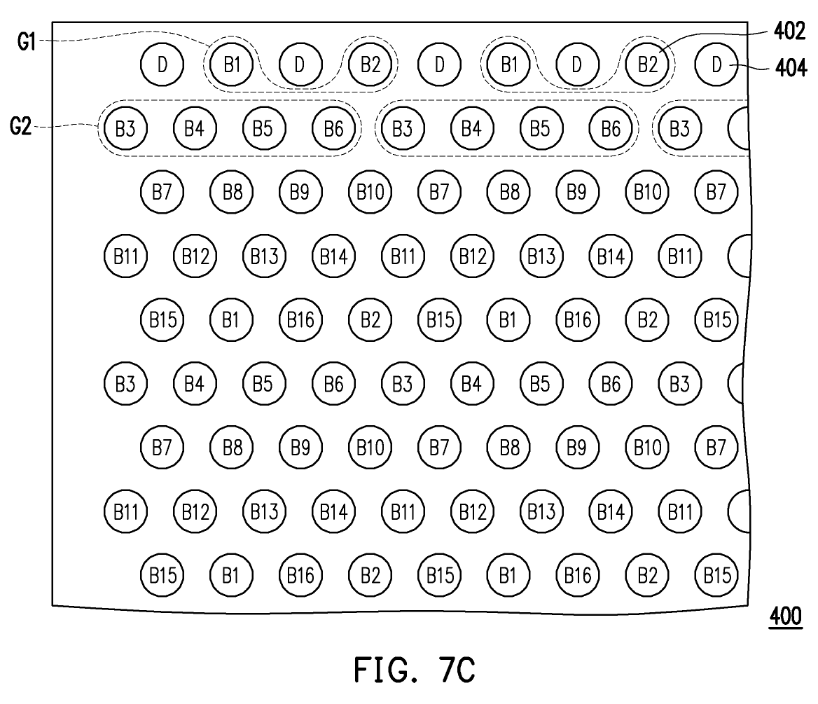

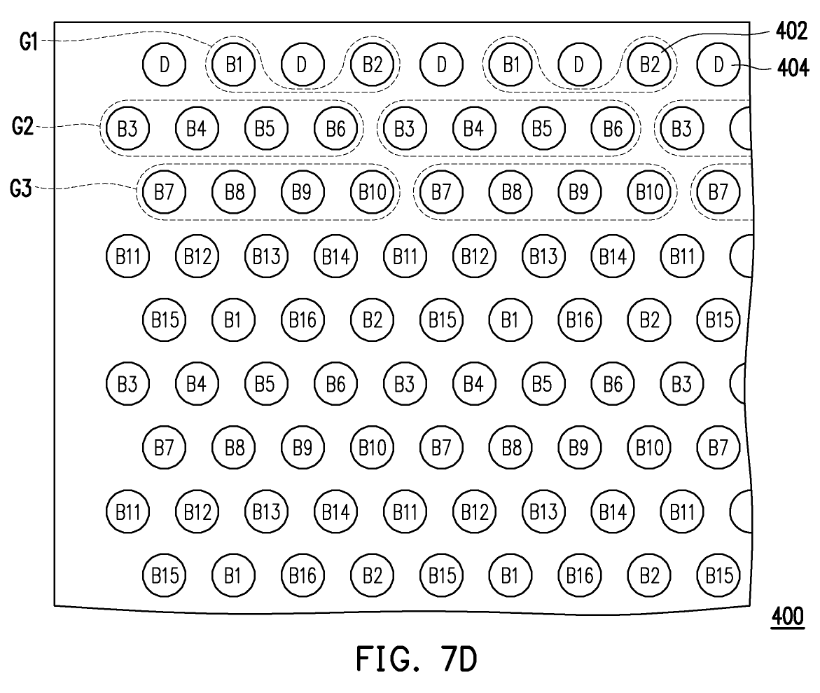

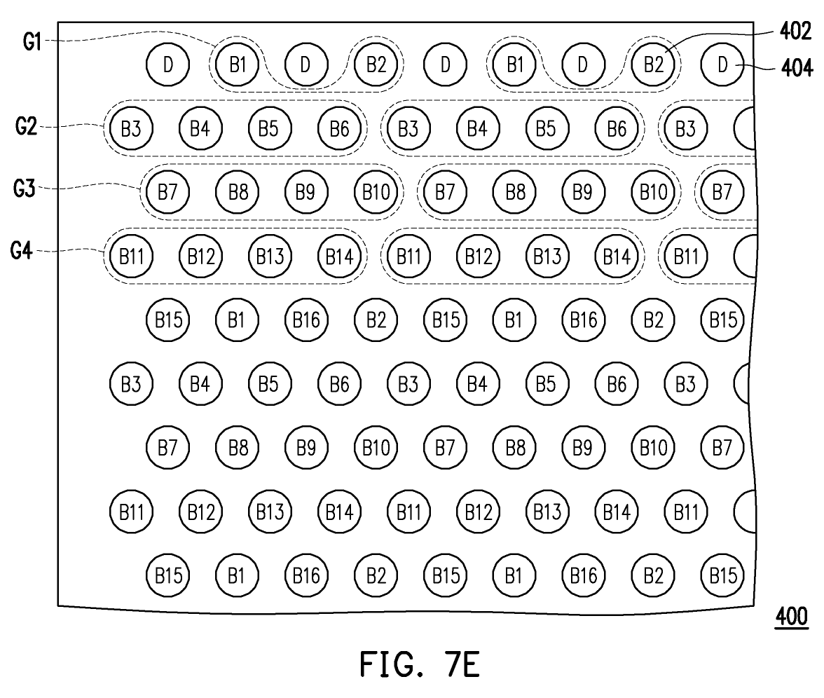

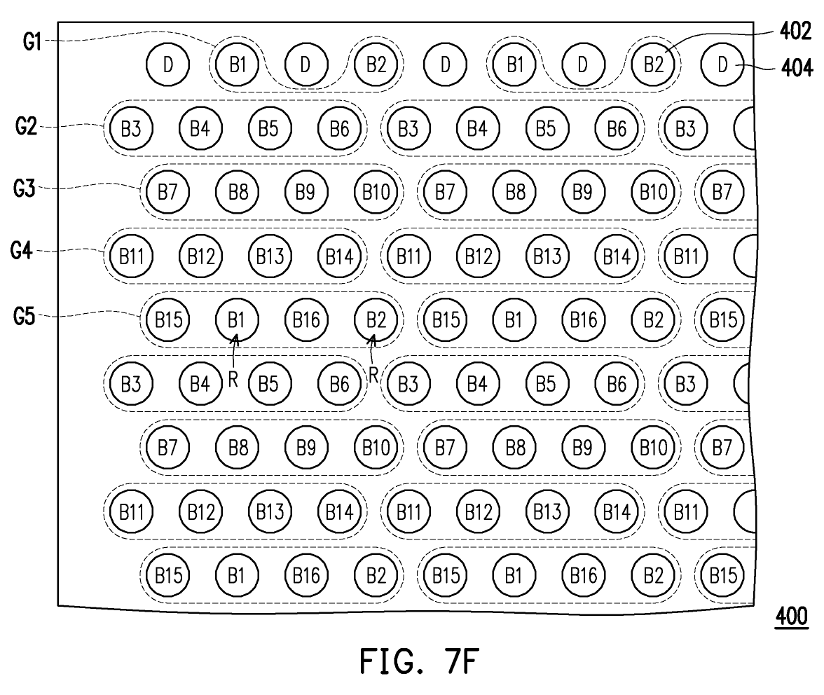

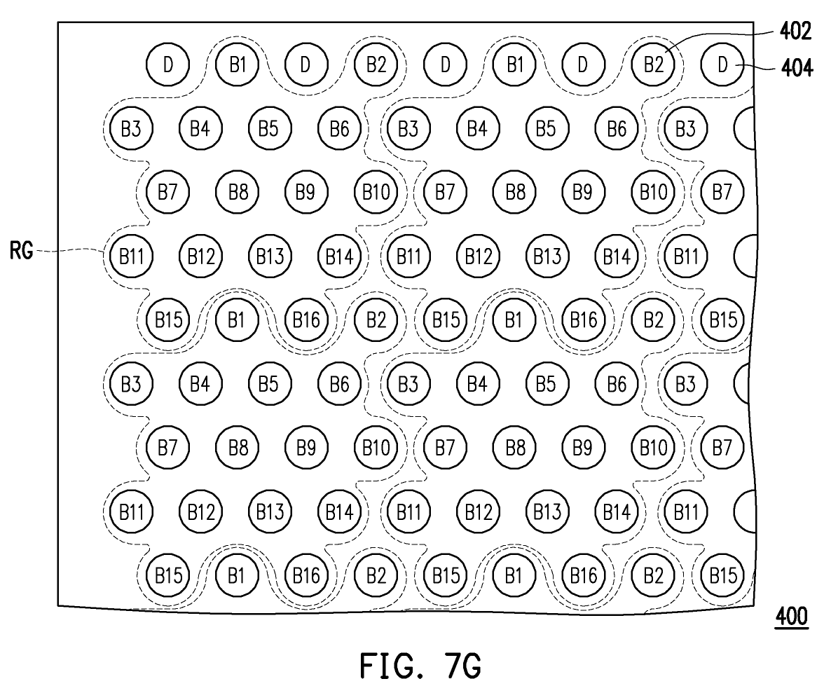

FIG. 6 and FIG. 7A to FIG. 7G illustrate a method for establishing a memory cell group according to a second embodiment of the disclosure. The steps of the method for establishing the memory cell group according to first embodiment of the disclosure are described below in conjunction with various components in the electronic device 10. Parts that are the same or similar to the aforementioned embodiment will not be described again.

With reference to FIG. 6 and FIG. 7A, in step 300, the processor 11 draws a layout pattern 400 of the memory cell array in the wafer according to the layout data LOD. Specifically, the processor 11 may first draw the layout structure diagram LOF of the memory cell array according to the structure information and the shape, type, and position information of each layer recorded in the layout data LOD, and then analyze the layout structure diagram LOF to obtain type of each memory cell 402 constituting the memory cell array. Accordingly, the processor 11 may draw the layout pattern 400 of the memory cell array by using different display effects (such as different colors or marks) to represent the memory cells 404 having different types.

As shown in FIG. 7A, the memory cell array presented by the layout pattern 400 includes the memory cells 402 and dummy memory cells 404. The first row of the memory cell array includes the memory cells 402 and the dummy memory cells 404, while the other rows of the memory cell array do not include the dummy memory cells 404. Except for including the dummy memory cells 404, the structure of the memory cell array presented by the layout pattern 400 is similar to the structure of the memory cell array presented by the layout pattern 200 and thus will not be further elaborated hereinafter. In some embodiments, the dummy memory cells are located in the first row of the memory cell array. In other embodiments, the dummy memory cells are located in a plurality of rows of the memory cell array.

In the memory cell array presented by the layout pattern 400, according to the types of the memory cells 402, the memory cells 402 are respectively marked as B1, B2, B3,..., and B16. In addition, the dummy memory cells 404 may be marked as D.

With reference to FIG. 6 and FIG. 7B, the processor 11 may recognize the layout pattern 400 of the memory cell array. In step 302, the processor 11 recognizes the memory cells 402 in the first row of the memory cell array presented by the layout pattern 400, and divides the memory cells 402 in the first row into a plurality of row groups G1. In this step, the dummy memory cells 404 are not classified. Therefore, in this embodiment, the memory cells 402 in the first row may be divided into the row groups G1, and the row groups G1 include two different memory cells 402 (marked as B1 and B2 respectively), which should however not be construed as a limitation in the disclosure.

In addition, in this embodiment, since the dummy memory cells 404 are simply disposed at the edge of the memory cell array presented by the layout pattern 400, the dummy memory cells 404 are not included in regions other than the edge of the memory cell array.

With reference to FIG. 6 and FIG. 7C, in step 304, the processor 11 recognizes the memory cells 402 in the second row of the memory cell array presented by the layout pattern 400, and divides the memory cells 402 in the second row into a plurality of row groups G2. It is then determined whether in the row groups G2 in the second row there are memory cells which are the same as the memory cells in the row groups G1 in the first row. In this embodiment, the row groups G2 include four different memory cells 402 (marked as B3, B4, B5, and B6 respectively), which should however not be construed as a limitation in the disclosure. In this step, it is determined that in the row groups G2 in the second row there are no memory cell which is the same as the memory cells in the row groups G1 in the first row, and thus the recognition step is continuously performed on the next row.

With reference to FIG. 6 and FIG. 7D, in step 306, the processor 11 recognizes the memory cells 402 in the third row of the memory cell array presented by the layout pattern 400, and divides the memory cells 402 in the third row into a plurality of row groups G3. It is then determined whether in the row groups G3 in the third row there are memory cells which are the same as the memory cells in the row groups G1 in the first row. In this embodiment, the row groups G3 include four different memory cells 402 (marked as B7, B8, B9, and B10 respectively), which should however not be construed as a limitation in the disclosure. In this step, it is determined that in the row groups G3 in the third row there is no memory cell which is the same as the memory cells in the row groups G1 in the first row, and thus the recognition step is continuously performed on the next row.

With reference to FIG. 6 and FIG. 7E, in step 308, the processor 11 recognizes the memory cells 402 in the fourth row of the memory cell array presented by the layout pattern 400, and divides the memory cells 402 in the fourth row into a plurality of row groups G4. It is then determined whether in the row groups G4 in the fourth row there are memory cells which are the same as the memory cells in the row groups G1 in the first row. In this embodiment, the row groups G4 include four different memory cells 402 (marked as B11, B12, B13, and B14 respectively), which should however not be construed as a limitation in the disclosure. In this step, it is determined that in the row groups G4 in the fourth row there is no memory cell which is the same as the memory cells in the row groups G1 in the first row, and thus the recognition step is continuously performed on the next row.

With reference to FIG. 6 and FIG. 7F, in step 310, the processor 11 recognizes the memory cells 402 in the fifth row of the memory cell array presented by the layout pattern 400 are recognized, and divides the memory cells 402 in the fifth row into a plurality of row groups G5. It is then determined whether in the row groups G5 in the fifth row there are memory cells which are the same as the memory cells in the row groups G1 in the first row. In this embodiment, the row groups G5 include four different memory cells 402 (marked as B15, B1, B16, and B2 respectively), which should however not be construed as a limitation in the disclosure.

In this step, it is determined that in the row groups G5 in the fifth row there are memory cells which are the same as the memory cells in the row groups G1 in the first row (the memory cells 402 marked as B1 and B2). At this time, in the row groups G5, the memory cells which are the same as the memory cells in the row groups G1 (the memory cells 402 marked as B1 and B2) are set as repeated memory cells R.

With reference to FIG. 6 and FIG. 7G, in step 312, the processor 11 collectively establishes the memory cells 402 (respectively marked as B15 and B16) other than the repeated memory cells R in the first row group G5 and the memory cells 402 (respectively marked as B1, B2, B3, B4, B5, B6, B7, B8, B9, B10, B11, B12, B13, and B14) in the first row groups (G1, G2, G3, G4) in each of the preceding four rows as one memory cell repeating group RG, a total of 16 memory cells 402.

In this embodiment, the memory cell repeating group RG includes 16 different memory cells 402, and the memory cells 402 of 16 types cover all types of memory cells in the memory cell array presented by the layout pattern 400. As such, based on the memory cell repeating group RG, the memory cell array presented by the layout pattern 400 may be considered as being composed of a plurality of the memory cell repeating groups RG. For instance, the repeated memory cells R (respectively marked as B1 and B2) in the first row group G5 in the fifth row, the memory cells 402 (respectively marked as B3, B4, B5, B6, B7, B8, B9, B10, B11, B12, B13, and B14) in the first row groups in the sixth to eighth rows, and the memory cells 402 (marked as B15 and B16) other than the repeated memory cells R in the first row group in the ninth row are established as another identical memory cell repeating group RG.

Besides, in this embodiment, after step 312, the processor 11 may further perform step 314 to determine whether in the first row group in the fifth row the memory cells 402 constituting the memory cell repeating group RG and the memory cells 402 other than the repeated memory cells R in the first row group G5 from the fifth row to the first row group in the ninth row are repeated. As such, the memory cell array is ensured to be composed of a plurality of the memory cell repeating groups RG.

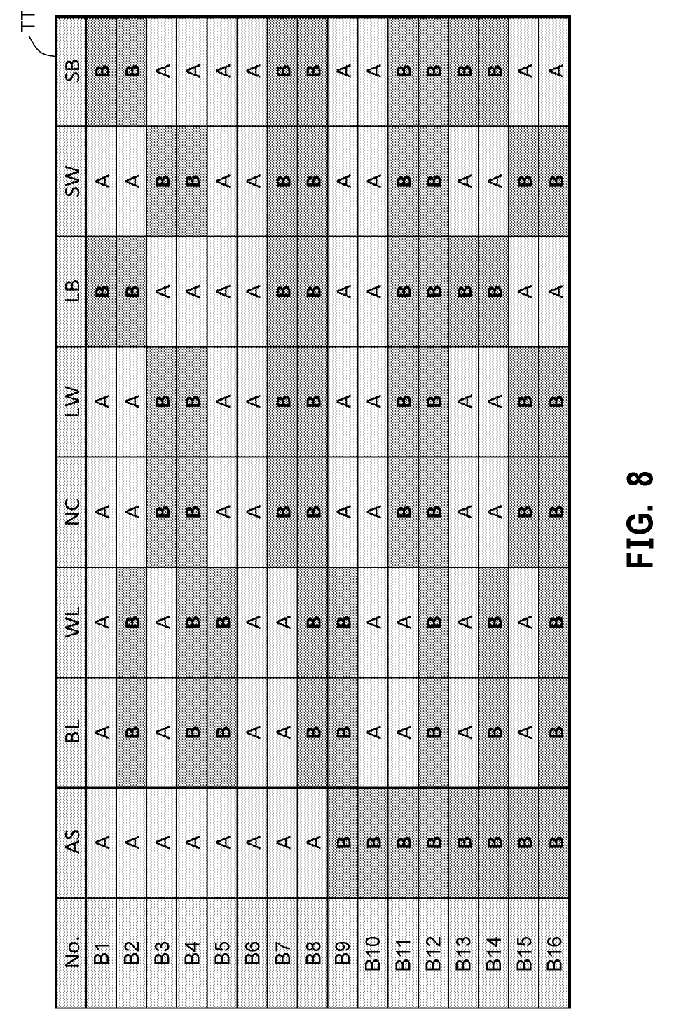

Finally, in step 316, the processor 11 generates a memory cell type table TTB2 associated with the memory cell repeating group RG. As shown in FIG. 8, the memory cell type table TTB2 lists the layers possessed by the memory cells 402 marked as B1~B16 in the memory cell repeating group RG, including AS layer, BL layer, WL layer, NC layer, LW layer, LB layer, SW layer, and SB layer. In the memory cell type table TTB2, the memory cell 402 marked as B1 has AS layer, BL layer, WL layer, NC layer, LW layer, and SW layer of Type A, and LB layer and SB layer of Type B. The memory cell 402 marked as B2 has AS layer, NC layer, LW layer, and SW layer of Type A, and BL layer, WL layer, LB layer, and SB layer of Type B, and so on.

To sum up, according to the method provided in one or more embodiments of the disclosure, the layout pattern of the memory cell array may be rapidly and accurately recognized and classified, so as to establish the memory cell repeating group, and then generate a corresponding memory cell type table to categorize the memory cells on the manufactured wafer. Thus, when defects are discovered due to subsequent analyses of product yield and failure modes, the specific application program may first be used to analyze which portion of the region (memory array) in the wafer the defects are concentrated in, and then combined with the generated memory cell type table to find out the layer types possessed by the memory cells where defects occur, thereby quickly identifying which step in the manufacturing process has problems. Therefore, the disclosure is conducive to improving the wafer manufacturing process and enhancing productivity and yield rate.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for establishing a memory cell group, adapted to an electronic device comprising a processor and a memory, the memory storing layout data, the method comprising:
drawing, through the processor, a layout pattern of a memory cell array according to the layout data, wherein the memory cell array comprises a plurality of memory cells, and different memory cells in the layout pattern are represented by different display effects;
performing, through the processor, a recognition step on the layout pattern, wherein the recognition step comprises:
dividing the memory cells in an n^{th} row of rows in the memory cell array into a plurality of row groups, wherein the row groups are identical, and the memory cells in the row groups are different; and
determining whether preceding n rows and succeeding n rows of the rows are repeated;
according to a recognition result of the recognition step, collectively establishing, through the processor, a portion of the memory cells as a memory cell repeating group, so that the memory cell array is composed of a plurality of the memory cell repeating groups; and
generating, through the processor, a memory cell type table associated with the memory cell repeating groups.

2. The method for establishing the memory cell group according to claim 1, according to the recognition result of performing the recognition step on the n^{th} row:
(a) when the preceding n rows and the succeeding n rows are repeated, collectively establishing the memory cells in a first row group in each row of the preceding n rows as the memory cell repeating group, and
(b) when the preceding n rows and the succeeding n rows are not repeated, performing the recognition step on a next row of the rows until (a) is satisfied.

3. The method for establishing the memory cell group according to claim 2, wherein the recognition step is performed on a first row of the rows in the memory cell array by the processor.

4. The method for establishing the memory cell group according to claim 1, wherein the recognition step performed on the layout pattern further comprises recognizing a layer stacking structure of each of the memory cells.

5. The method for establishing the memory cell group according to claim 4, wherein the difference in the memory cells comprises a difference in the layer stacking structures of the memory cells.

6. A method for establishing a memory cell group, adapted to an electronic device comprising a processor and a memory, the memory storing layout data, the method comprising:
drawing, through the processor, a layout pattern of a memory cell array according to the layout data, wherein the memory cell array comprises a plurality of memory cells and a plurality of dummy memory cells, different memory cells in the layout pattern are represented by different display effects, and a first row of rows in the memory cell array comprises the dummy memory cells;
performing, through the processor, a recognition step on the layout pattern, wherein the recognition step comprises:
dividing the memory cells in an n^{th} row of the rows in the memory cell array into a plurality of row groups, wherein the row groups are identical, and the memory cells in the row groups are different; and
determining whether in the row groups in the n^{th} row there are memory cells which are identical to the memory cells in the row group in the first row, where n is a positive integer greater than 1;
according to a recognition result of the recognition step, collectively establishing, through the processor, a portion of the memory cells as a memory cell repeating group, so that the memory cell array is composed of a plurality of the memory cell repeating groups; and
generating, through the processor, a memory cell type table associated with the memory cell repeating groups.

7. The method for establishing the memory cell group according to claim 6, according to the recognition result of performing the recognition step on the n^{th} row:
(a) when in the row groups in the n^{th} row there are memory cells which are identical to the memory cells in the row group in the first row, setting the memory cells in the row groups in the n^{th} row that are identical to the memory cells in the row groups in the first row as repeated memory cells, and collectively establishing the memory cells in the row groups in the n^{th} row other than the repeated memory cells and the memory cells in the first row group in each of preceding (n-1)^{th} rows of the rows as a memory cell repeating group, and
(b) when in the row groups in the n^{th} row there is no memory cell which is identical to the memory cells in the row groups in the first row, performing the recognition step on a next row of the rows until (a) is satisfied.

8. The method for establishing the memory cell group according to claim 7, wherein the recognition step is sequentially performed on the first row and a second row of the rows in the memory cell array by the processor.

9. The method for establishing the memory cell group according to claim 8, wherein after establishing the memory cell repeating group, the method further comprises:
determining whether the memory cells in the memory cell repeating group other than the repeated memory cells from the first row group in the n^{th} row to a first row group in a (2n-1)^{th} row of the rows are repeated.

10. The method for establishing the memory cell group according to claim 6, wherein the recognition step performed on the layout pattern further comprises recognizing a layer stacking structure of each of the memory cells.

11. The method for establishing the memory cell group according to claim 10, wherein the difference in the memory cells comprises a difference in the layer stacking structures of the memory cells.
